(19) United States
(12) Patent Application Publication
(10) Pub. No.: US 2011/0234787 A1
(43) Pub. Date: Sep. 29, 2011

(54) OPTICAL ALIGNMENT SYSTEM, SUCH AS FOR AN ORBITING CAMERA

(76) Inventors: George Tyc, Delta (CA); Nicholas Richard Waltham, West Berkshire (GB); Ian Allan James Tosh, Oxfordshire (GB); Nigel Morris, Oxfordshire (GB); Ruben Laurence Edeson, Oxfordshire (GB)

(21) Appl. No.: 13/122,545

(22) PCT Filed: Oct. 15, 2009
(86) PCT No.: PCT/CA2009/001464

§ 371 Date: Jun. 16, 2011

Related U.S. Application Data
(60) Provisional application No. 61/105,760, filed on Oct. 15, 2008.

(51) Int. Cl. H04N 5/232; H04N 7/18; H04N 5/225

(52) U.S. Cl. 348/82; 348/E07.085; 348/E05.024; 348/E05.043

(57) ABSTRACT

A system and method for adjusting an optical system, such as that of a telescope in a satellite where the optical system is misaligned after launch of the satellite, includes obtaining at least one image captured by the optical system of the telescope, wherein the captured image is of at least one star. The system and method then analyzes the at least one image captured and generates adjustment signals to control at least one actuator to move at least one movable element in the optical system and perform positional correction of the optical system. Other details of the system and method are provided herein.

### CROSS-REFERENCE OR RELATED APPLICATION

This application claims the benefit of the assignee's U.S. provisional application No. 61/105,760, filed Oct. 15, 2008, entitled “Optical Alignment System, Such As For An Orbiting Camera”.

### BACKGROUND

Previously, most space-based optical telescopes have been precisely aligned on the ground, and in order to maintain that precision through launch vibration, have been mounted into large and heavy frames and/or used higher cost materials and processes Significant effort is expended to remove all residual stresses in the telescope structure to minimize any shifts of the optical elements that can occur during launch.

Such prior telescopes required extensive testing to ensure that the telescope structure was properly aligned and was sufficiently fortified to endure the stresses of launch. Further, given the heavy frames and other structures (or higher cost materials and processes) that are required to maintain the system rigidly during launch stress, additional costs in energy have been required to put such a heavy payloads into space.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 illustrates an isometric, cross-sectional view (taken along the line 1-1 of FIG. 5A) of an example of a spacecraft with telescope and optical camera.

FIG. 2 is a cross-sectional, elevational view of the example of FIG. 1.

FIG. 3 illustrates an example of an optical system layout.

FIG. 4 illustrates an example of back-end optics showing an exit pupil and intermediate image.

FIG. 5A is a front isometric view of the telescope of FIG. 1.

FIG. 5B is an enlargement of a portion of FIG. 5A showing a single positioning mechanism and support truss.

FIG. 6 illustrates an enlarged and partial cross sectional view of the positioning mechanism shown in FIG. 5B.

FIG. 7 illustrates an example of aberrated and corrected star field images.

FIG. 8 is a block diagram of electronics for automatically positioning or aligning the optical system.

FIG. 9 is a flow diagram of a process for automatically aligning the optical system using the components shown in, e.g. FIGS. 1 to 9.

### DETAILED DESCRIPTION

Described in detail below is on-orbit optical alignment system that combines:

1. An Optical Design or Assembly,

2. In-Orbit Star-Scanning,

3. Optical Alignment Optimization Algorithms, and,

4. A Mechanized Active Optics System with on-board supporting electronics.

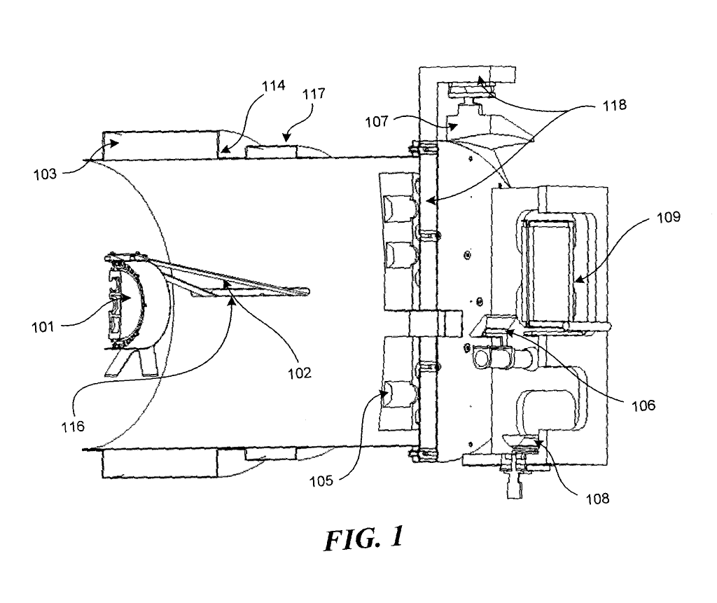

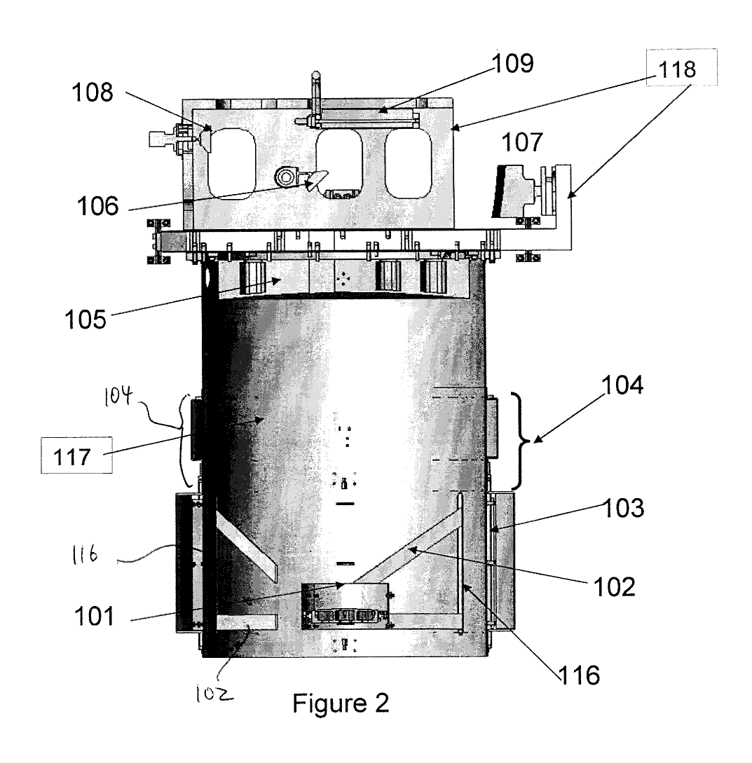

These components may be contained within a single spacecraft to automatically align optics of the spacecraft. The optical design of the camera is designed so that post launch alignment errors are correctable with the movement of just one optical element, a secondary mirror 101 shown in FIGS. 1, 2 & 5, which may move about three degrees of freedom. (Secondary mirror 101 is sometimes referred to herein at M2 mirror.)

FIG. 1 shows a suitable adjustment mechanism where the mirror 101 is mounted on a truss 102 that passes through a slot 116 on a main body 117 of the telescope, and is attached to a push rod 103 that can be moved by a motor or other actuator. The main body 117 of the telescope contains a primary mirror 105 mounted on a rear optical assembly frame 118 that maintains alignment with other optical elements.

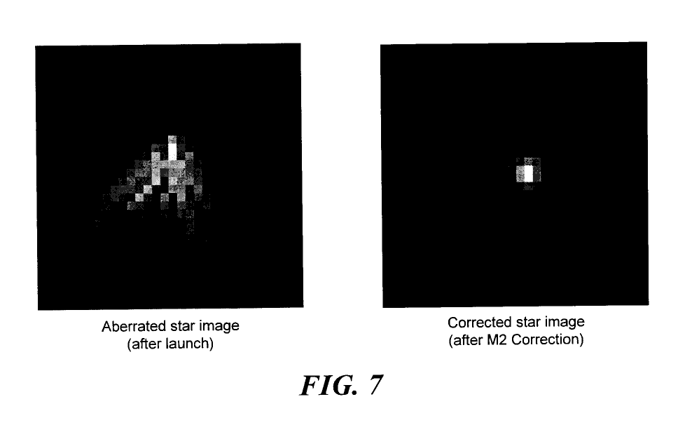

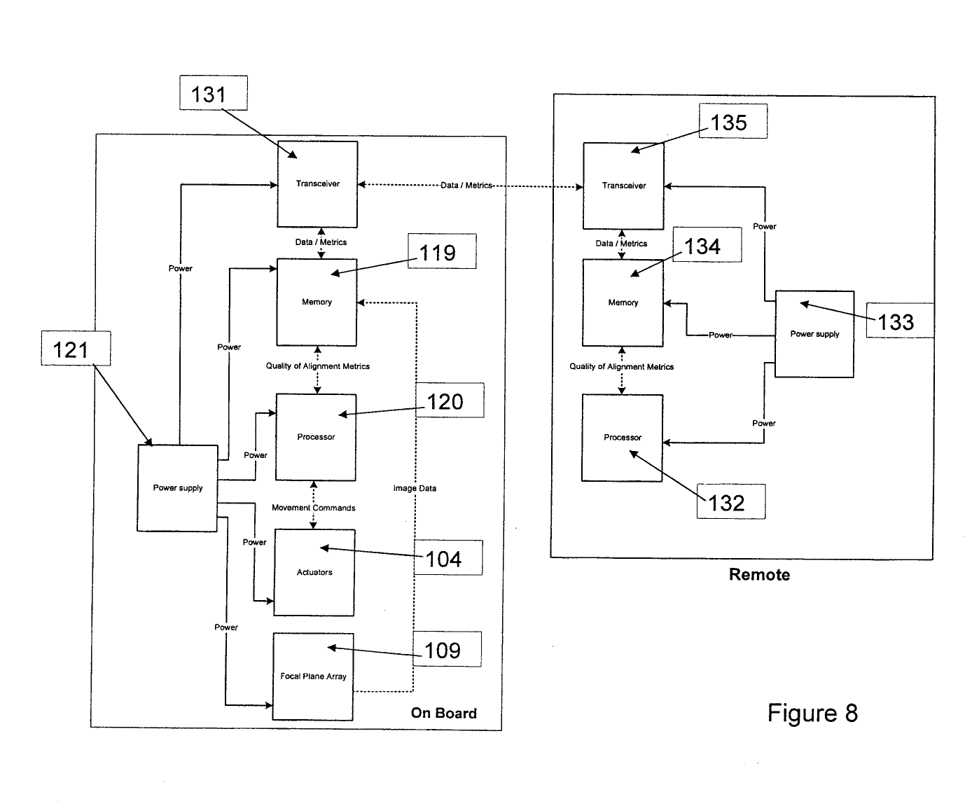

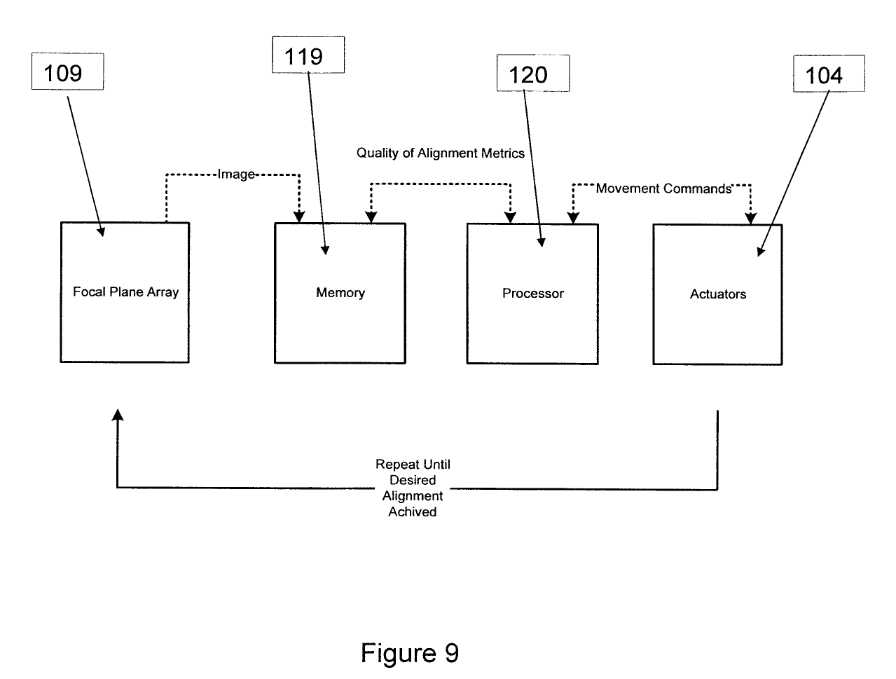

Once in space, a focal plane assembly 109 using this, or a similar system, carries out in-orbit scanning of the star field, to collect imagery of point targets from the spacecraft's position in orbit. Aberrations displayed on the focal plane (i.e., the distortions of the star images) allow for determining movement required from the adjustment mechanisms, via optical alignment optimization algorithms (described below), in order to align the telescope. See FIG. 7 for sample distortions, see FIG. 8 for a block diagram, and see FIG. 9 for a flow diagram of the alignment process, all discussed herein.

The systems described herein allow for improving the optical performance of any existing systems, not just the telescope system described in detail below. While described generally herein as a system to gather fight, the optical assembly may also act as part of an emitter such as a laser pointer or LIDAR (Light Detection and Ranging) device, as well as part of a transmission/reception system for position monitoring, via interferometers, on formation flying satellites, etc. In a LIDAR application, the shape of the projection of the laser dot would act in a similar manner to the star image on the system's focal plane assembly 109. As an example for this new embodiment, the system elements would include, in addition to those described herein, a dot quality measurement device as well as a laser emission cavity itself within the housing. On reception of light, the focal plane assembly and the optics of the telescope would act largely as already described. However on emmittence of the laser, the beam would be directed through an optical assembly used to condition the beam which can have at least an optical element that is adjustable to improve the light beam qualities. A small portion of the beam would then be separated by a partially silvered mirror and projected on to the dot quality measurement device, that would by recording the concentration of energy from the light beam, perform an assessment of the quality of alignment in a similar manner to the images otherwise collected by the focal plane assembly.

Atmospheric LIDARs are limited by the intensity of beams they can direct into the atmosphere from space. Hence they require sensitivity in their receivers and large primary mirrors. As primary mirrors increase in size a stable rigid structure becomes unfeasible and active corrections are necessary. Long-range position monitoring using laser interferometry may also require that the laser beam be conditioned using an appropriate optical system to allow for efficient transmission and reception of the beam. The approach described herein would permit an optical element to be adjusted in this alternative optical system to thereby condition the beam to improve the interferometry operation.

The alignment method described herein can be used immediately after launch. However, the mechanisms are designed such that it would be possible to repeat the alignment process at any time during the mission. The systems and processes described herein may be applicable to various optical systems, namely any optical systems designed to be re-aligned remotely and in situ, such as in space or in locations where a human cannot perform the alignment. Such other locations may include use in or near nuclear reactors, within chemically or biologically contaminated areas, or in other human-hazardous environments. Overall, the housing and other system components are built to withstand the rigors of non-standard environmental and atmospheric conditions in which humans exist, such as in space, undersea, etc.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention has many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in the Detailed Description section.

The headings provided herein are for convenience only and do not necessarily affect the scope or meaning of the claimed invention.

Telescope Design Overview

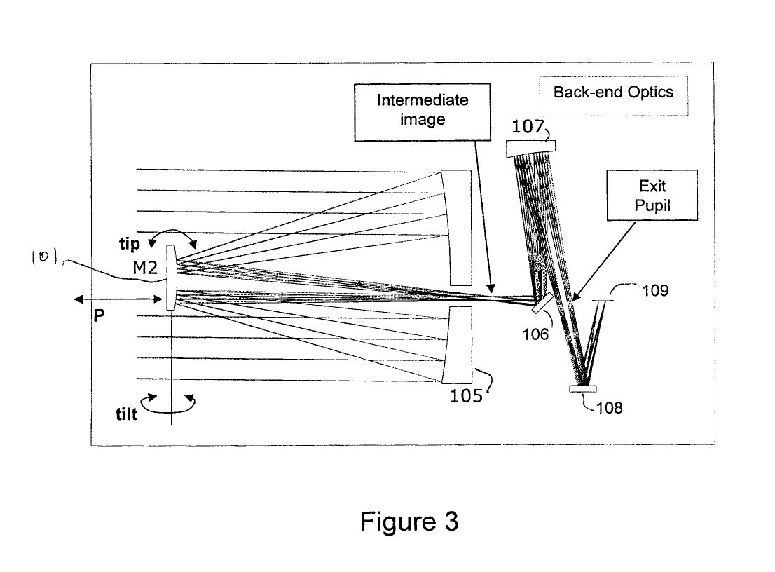

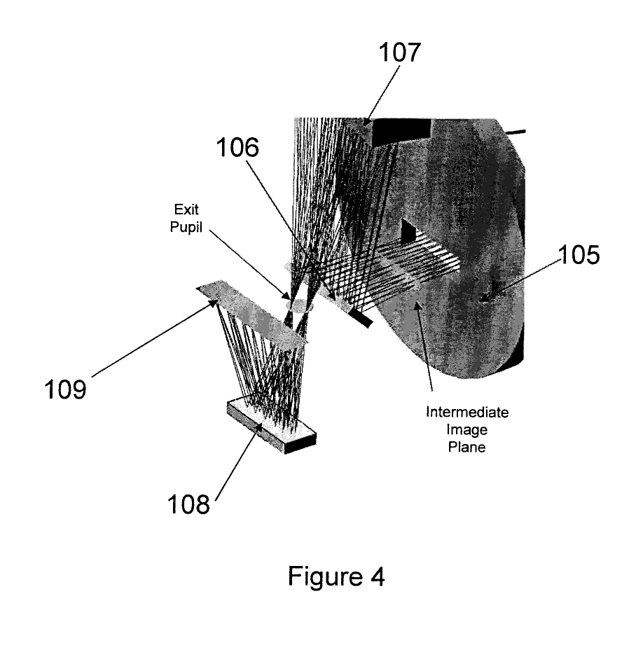

The telescope optical design in the example depicted in the Figures is a Korsch Three Mirror Anastigmat (TMA) design comprising a large primary mirror M1 (element 105), a smaller secondary mirror M2 (element 101) located in front of M1, and a tertiary mirror M3 (element 107) located behind M1. Two fold mirrors 106 and 108 are used to fold the optical path behind M1 to achieve a more compact design. An intermediate image is formed behind M1 (see FIGS. 3 and 4) allowing the use of a field stop or exit pupil to define the field of view and help block extraneous visual noise. The optical path converges on the focal plane assembly 109, which is mounted transversely at the back-end of the telescope. The focal plane assembly 109 may include any of various electronic imaging devices know today or later developed. Note that the optical assembly is aligned by the movement of an entire or discrete optical element (M2 mirror) rather than deforming an optical element or moving a portion of an element.

The optical design has the ability to accurately adjust mirrors in relation to each other using precision adjustment mechanisms described below, which perform the optical alignment. This allows optical aberrations induced in the system during launch (e.g., defocus, misalignment) to be corrected in orbit to thereby restore high quality optical performance. In this specific optical design, the M2 mirror 101 is the adjustable optical element. The telescope optical design is optimized in this example so that motion of M2 mirror with only 3 degrees of freedom (i.e., tip, tilt and piston) is sufficient to perform the corrections to compensate for small shifts in all of the optical elements that can result during launch. The movement in the piston direction is shown as double-ended arrow P in FIG. 3; tip is shown by the double-ended curved arrow in FIG. 3, while tilt of M2 mirror is perpendicular to the plane of FIG. 3.

As described in detail below, adjustment assemblies 104, such as motor-driven push rods, adjust the secondary mirror 101. A sensor (not shown) helps determine movement or displacement of the adjustment assemblies. Precision displacement sensors may be used within each adjustment assembly 124, and several options are available such as linear potentiometers, linear variable differential transformers (LVDTs), optical “rotary” encoders, or other encoders. Output from the precision displacement sensors are provided to the processor 120 which controls movement of the actuators. Note also, that in the case where the actuator includes a stepper motor for the adjustment assembly, the system may avoid displacement sensors and instead simply count the number of steps commanded in either direction to determine the actuator position.

While the TMA optical design is described in detail herein, various other optical designs or assemblies may be employed. Further, while a particular adjustment system is described in detail herein, various other adjustment assemblies may be provided.

Active On-Orbit Optics (AO³) System

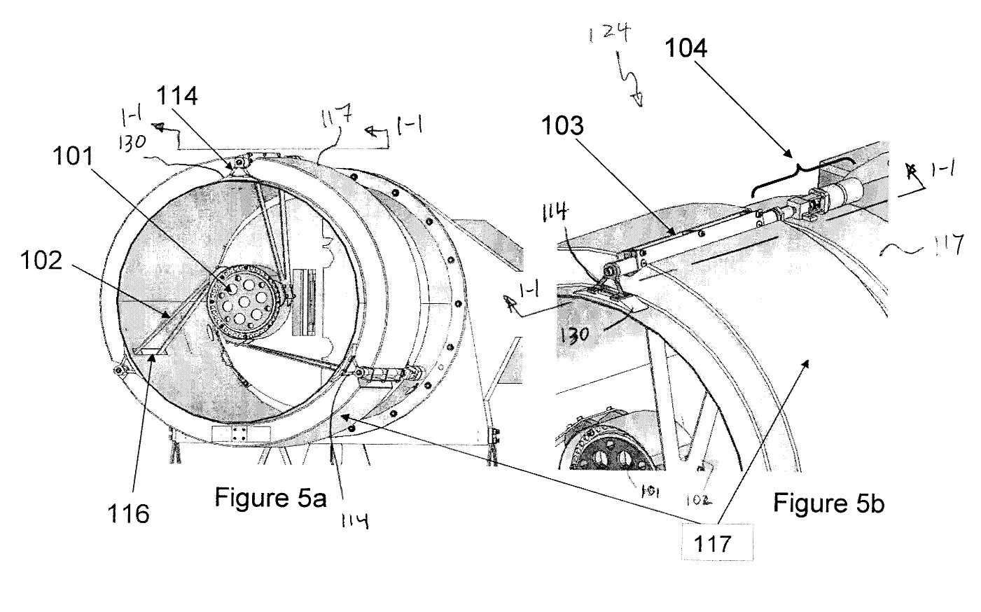

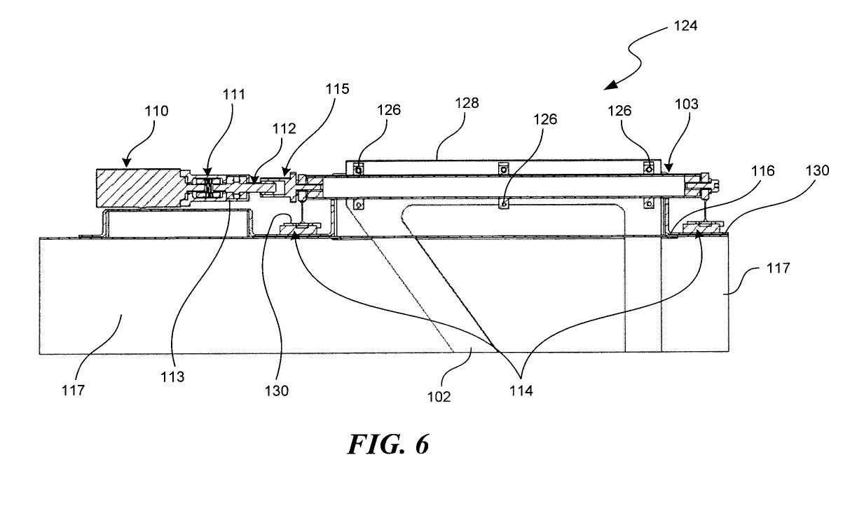

Active parts of the alignment system include three small linear actuator assemblies 104, each attached to one of three flat and triangularly shaped trusses 102 that hold the secondary mirror 101 in place. These trusses are arranged at 120 degree intervals around an outer edge of the M2 mirror housing (see FIG. 5). The trusses can be made from any material with highly predictable elastic characteristics (e.g. Carbon Fibre Reinforced Polymer (CFRP), aluminum or titanium). These components can adjust the secondary mirror 101 in order to correct aberrations by movements known as tip and tilt (i.e., the angular rotation of the mirror about two orthogonal axes), and piston (i.e., axial distance from the primary mirror). While three trusses are shown, arranged regularly about the cylindrical main body 117 of the telescope, more or fewer trusses and actuators may be employed and such trusses may be arranged in various configurations.

Referring to FIG. 5, the actuator assemblies 104 use an actuator 110, such as a miniature motor with integral gear box, and a lead screw 112 to allow for axial adjustments of each truss 102 supporting the M2 mirror, via a push rod 103 that is supported by flexures 114 on either end of the push rod. The lead screw 112 is supported by a pair of preloaded bearings 113, and is attached to the actuator 110 via a flexible coupling 111.

The push rod 103, fastened to each truss 102 by pins 126 and clamp 128, is mounted on a set of flexures 114 on either end of the push rod to provide high stiffness in all degrees of freedom except in the axial direction of the telescope body 117 (the optical axis of the telescope/camera). The flexures 114 are attached to the main telescope body 117 by way of mounts 130. This allows the adjustment mechanism 104 to push or pull on each push rod 103 in the axial direction independently, so as to affect the desired motion of the M2 mirror 101.

The trusses 102 holding the M2 mirror 101 are designed from a strong but flexible carbon-fibre material (or other suitable material), such that the truss is allowed to deform and enable the translations of each truss to become tilts of the M2 mirror 101.

Each movement of the push rod 103 will result in the M2 mirror position and orientation being altered by a mixed degree of tip, tilt, and piston, with fixed proportions as well as to a much smaller degree the other 3 degrees of freedom (translations in the lateral axis and rotation about the optical axis). Coupling between degrees-of-freedom can be assessed by analysis and ground testing, and relevant transfer or movement functions determined. These proportional changes are then used for finding the optimum positions, as noted herein.

In one example, the actuator 110 includes a stepper motor that has 200 steps/revolutions and an integral gearbox that reduces the step size from about 1.8° to 0.36°, a reduction of 5:1. This in turn drives the lead screw 112, which has a 1 mm pitch and which engages with a matching lead screw nut 115 attached to the pushrod 103. Therefore a single step of the motor causes a 1 micron movement of the nut and pushrod. The mechanism or actuator assembly 104 may have a total range of movement of about ±1.0 mm allowing the M2 mirror to be translated by the same amount, or by differential movement of the three mechanisms, allowing a tip or tilt of up to ±0.23 degrees. The precision displacement sensors indicate to the processor the actual position of the pushrods, rather than having the processor relying on step counting. Overall the system gearing, friction and détente torque are selected so that the position of the M2 mirror is held against the restorative force of the flexures 114 once the motors are powered-off. Therefore optical alignment will be maintained in an unpowered state.

The above describes only one example: many other ways to adjust optics can be implemented. For example, the system can use a different optical design, and/or use a different mirror and/or use more than one mirror to act as the compensating elements to perform the alignment in space. Alternatively or additionally, the system may use a different number of degrees of freedom (DOF) for the compensating mirror(s) where using more DOF will generally improve the alignment performance. The particular example described above offers a high degree of compensation capability in a low cost and low risk manner allowing the use of individual components for the mechanization that are readily available for space use. A number of alternative mechanisms are of course also possible.

Determining the M2 Correction

Referring to FIGS. 8 and 9, a correction system for moving mirror 101, includes a power supply 121, a focal plane assembly 109, actuators 104, a memory unit 119 to hold the image data, and a processor 120 to host a decision engine and control parameters needed to move the actuators. These components act together via the flow described in FIG. 9. The implementation of the decision algorithms can also be ground based, as shown in FIG. 8. With the addition of a transceiver to both on-board and remote segments (transceivers 131 and 135), an equivalent to the on-board system can be remote or ground based items by providing a remote processor 132, power supply 133, and memory 134.

The power supply 121 may be any known or later developed power supply, which for spacecraft may include a solar array, although other forms of generating power include biological, chemical, nuclear, and similar power generation means. Of course, any variety of power source may be employed, including a remote power source for the system, such as in a tethered application (e.g., deep undersea applications where power is provided through a cable).

The memory 119 may be any volatile and/or non-volatile memory currently employed or later developed. Likewise the processor 120 may include one or more microprocessors, microcontrollers, field programmable gate arrays (FPGA) or other logic arrays, custom circuitry such as application specific integrated circuits (ASICs), and for forth. In some applications, the memory and the processes may be monolithically integrated.

The power supply 121 provides power to components of this system, including the memory 119, processor(s) 120, actuator 104 and focal plane assembly 109. Image data received by the focal plane assembly is provided to and stored in the memory 119, to be later analyzed by the processor 120. The processor analyzes this image data to determine a quality of alignment metrics or otherwise generate signals or movement commands for the actuators 104. In response thereto, the actuators adjust the optics (M2 mirror), and provide feedback to the processor in the form of signals from precision displacement sensor. The processor can then ensure that the actuators are properly controlled to adjust the optical system.

The focal plane assembly 109 may include any known imaging system. The system points the telescope into space and uses images of the star field to determine the M2 mirror system correction required. In the specific example described in the Figures, the telescope employs a pushbroom imager because the telescope is intended for earth imaging applications from low earth orbit, therefore it operates by scanning over the areas of interest using the satellite's orbital motion. Therefore, in this case, the telescope scans slowly past the star field to acquire an image.

In other embodiments, the telescope may be designed to image an area without scanning (e.g., using an array detector in its focal plane). In this case the telescope would be inertially fixed while acquiring the star field image. The region of space will be selected to have numerous bright stars across the telescope field of view.

All optical alignment can be done on board the satellite. Alternatively or additionally, a remote system, such as a ground-based or terrestrial station, can receive images provided by the system, process or analyze those images, and provide back signals to move the actuators and align (or realign) the optics. The remote system is geographically remote from the on board system. In the example shown in FIG. 8, a remote system includes components similar to those on board the satellite, namely one or more processors 132, a power supply 133, one or more volatile or non-volatile memories 134, and a transceiver 135 that communicates with the on board transceiver 131. The transceivers 131 and 135 may communicate using any known wireless frequencies and protocols, and in other applications, may include a tether so that the transceivers communicate over a cable. Further details regarding interactions between the on board and remote components is provided below.

Referring to FIG. 9, a flow diagram illustrates how the components of FIG. 8 operate to adjust alignment of the optical system. The focal plane assembly 109 generates an image of the star field and provides that image to the memory 119. The processor 120 accesses the stored image and analyzes the image to determine how the optics should be moved, as described below. Based on the determination, the processor provides movement commands to the actuators 104 to move the optics (M2 mirror). The actuators provide a signal back to the processor 120 to indicate precise displacement of the actuators and thus movement of the M2 mirror.

The process is then repeated one or more times until the optics are appropriately aligned. For example, the focal plane assembly 109 again generates an image which is stored in the memory 119. The processor 120 analyzes the new image and coordinates movement of the actuators 104. Following one or more iterations of this process, an initial image (such as the left-hand image in FIG. 7) is transformed to a corrected image indicating appropriate alignment of the optical system (the right-hand image in FIG. 7).

To determine the M2 mirror correction required in the tip, tilt and piston degrees of freedom, at least one of three methods exist to establish the degree of misalignment in the optical elements:

1) To move the assembly through a given range of each mechanism in steps, and perform a “search” by collecting an image at each position and checking to see which position is optimal;

2) To analyze a point spread function of a point target on the focal plane assembly 109 so as to calculate any positional errors of the optical elements, and adjust accordingly; and

3) To combine both 1) and 2) in order to facilitate a much smaller “search” activity.

In the first method, for each of the star field images taken, M2 mirror will be placed in a pre-selected set or series of tilt and displacement positions. For example, the actuators may move from 0 to 100% of their range, in 10% intervals. If the telescope is misaligned, the perfect pin-point light sources (which are the stars), will appear to be aberrated (out of focus and smeared); see FIG. 7. The process of FIG. 9 is used to make corrections by calculating a “metric” (such as encircled energy per pixel, in Watts) for each point target in each image taken.

The mechanisms or adjustment assembly run through their full ranges in a regular, incremental, step by step manner. Then the particular M2 mirror position that corresponds to the best value for the “metric” is selected as the new position after the correction. The processor may cause images at each increment of the adjacent assembly to be stored, with the corresponding position signals. The processor may then analyze each stored image to identify a “best” image that corresponds most closely with an ideal image, e.g., one that has the least amount of smear. The processor then commands movement of the actuators based on the stored position signals that correspond to the best stored image.

It is possible that the stored position signals provided to the actuators provide sufficient data to appropriately align the optics such that no further adjustment is required. However, to help ensure that the optics are indeed appropriately aligned, or to later provide alignment of the optics if they become misaligned during the course of the mission, the process may be repeated. In this example, a set of images taken among a discrete range of movements of the actuators results in a discrete set of obtained and stored images. This provides a “coarse” adjustment or alignment of the optics. Thereafter, the system may then provide a “fine” adjustment by capturing a series of images taken after moving the actuators small increments before and after the position setting associated with the “best” image. Thus, in this example, the actuators may be moved only a small fraction of their range about the current coarse position and images taken at each of several discrete intervals. These fine adjustment images are then analyzed by the processor to identify an optimal image and position signals associated with that optical image provided to the actuators to make the fine adjustment and appropriately align (or re-align) the optics.

Alternatively, the stored images may be wirelessly sent to a remote or terrestrial station to be analyzed. Commands may then be uplinked to the spacecraft to perform the M2 correction, and the process is repeated several times until a final alignment is achieved that provides the required optical performance. In this example, the images may be captured and streamed down to the remote station (between transceivers 131 and 135) and stored in the remote memory 134, to be later analyzed by the processor 132. Alternatively, all images may be captured and stored in the on board memory 119 to be later transmitted in a batch for storage in remote memory 134. The remote processor 132 analyzes images stored in the memory 134 to determine appropriate actuation commands to be transmitted by transceiver 135, received by transceiver 131, and acted upon by processor 120 to move on board actuators 104.

In a second method, a single star field image and specific nature of star aberrations across the field of view or stored image provide information about how the telescope is misaligned. This information can then be used to determine the M2 correction required. An example of a common type of aberration is shown in FIG. 7, where the simulated star aberration has a triangular-like shape, which is often associated with a type of aberration called Coma, where such aberrations are exaggerated by optical misalignment. The shape of the point target on the focal plane is usually referred to as a point spread function. It is this particular shape that is significant and can be used to determine the M2 mirror correction.

In a simple example, if the triangular smear extends down or to the “bottom” of the stored image, the M2 mirror should be moved so that the “bottom” portion of the mirror that corresponds to the bottom of the image is moved upward. After the correction has been applied once (by moving the M2 mirror), the point spread function is re-assessed and the process is repeated until the level of optical performance required is achieved (FIG. 9). This approach is particularly useful in an autonomous implementation performed entirely on the spacecraft, without an operator or terrestrial processing in the loop. This would allow performing the correction fairly frequently at different locations in orbit if desired. Of course, the remote station may perform this processing, whereby the transceiver 131 transmits stored images to the remote transceiver 135 to be stored in remote memory 134 and analyzed by the processor 132. An operator could manually review the images to help ensure or adjust alignment of the optics by visually analyzing an image for the type of distortion, and identify an appropriate algorithm to align the optics to correct that distortion.

In a third method, the two approaches described above are combined to perform autonomous M2 corrections using a smaller set of star field images gathered at pre-set M2 positions to achieve an improved optical alignment. These approaches may be applied to any embodiment of the system as described above where different optical designs can be used and with different compensating optical elements (e.g., more than 1 optical element could be adjusted).

This alignment process may likewise be performed fully autonomously onboard the spacecraft where the process is applied by the onboard processor 120 and the process is iterated until the desired optical performance is achieved. Alternatively it is possible to do this by control from the ground with an operator in the loop. In this case, the star images are downlinked to the ground via the transceiver 131 and an operator would assess the images and perform the analyses required to establish the correction for the M2 mirror, and this process is repeated until the desired optical performance is achieved.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways, Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6). Accordingly, the applicant reserves the right to pursue additional claims after filing this application to pursue such additional claim forms, in either this application or in a continuing application. cm I/we claim:

1. A remotely adjustable optical system, comprising:
an optical assembly having at least one movable optical element, and an imaging element for generating an image of a field of view of the optical system;
an adjustment assembly having at least one actuator coupled to the movable optical element of the optical assembly;
at least one memory for storing images generated by the imaging element;
at least one processor coupled to the actuator and the memory, wherein the processor is configured to execute an optical alignment program to:
analyze at least one of the stored images;
provide adjustment signals to the actuator based on the analysis of the stored image to cause the actuator to actuate the movable optical element;
instruct the imaging element to produce a new image following the actuation of the movable optical element;
analyze the new image; and
again provide adjustment signals to the actuator based on the analysis of the new image to cause the actuator to again actuate the movable optical element and align the optical assembly,
wherein the alignment of the optical assembly is not a focusing of the optical assembly or is not solely a focusing of the optical assembly;
a housing for carrying the optical assembly, the adjustment assembly the memory and the processor as a unit,
wherein the housing, the optical assembly, the adjustment assembly, the memory, and the processor are configured to be positioned in space or in an environment hazardous to humans,
wherein the optical assembly is misaligned when positioned in space or in the hazardous environment, but before the processor executes the optical alignment program; and
wherein the actuation of the movable optical element consists essentially of moving at least one entire or discrete optical element in the optical assembly, and not moving or deforming a portion of the optical element.

2. The remotely adjustable optical system of claim 1 wherein the housing, the optical assembly, the actuator, the memory, and the processor are configured to be positioned in space as a satellite,
wherein the stored images are of a star field,
wherein the optical assembly includes a telescope having a stationary primary mirror and the movable optical element is a secondary mirror of the telescope, and
wherein the processor analyzes the stored images of the star field to determine a positional correction of the secondary mirror to align the telescope.

3. The remotely adjustable optical system of claim 1 wherein the optical assembly includes only a single movable optical element,
wherein the single movable optical element is a lens or mirror,
wherein at least three actuators move the single movable element about at least three degrees of freedom to perform alignment correction to compensate for misalignment of other optical components of the optical assembly and a focal plane of the optical system.

4. The remotely adjustable optical system of claim 1 wherein the adjustment assembly includes:
multiple support trusses each secured at one end to the movable optical element;
multiple push rods each secured to a free end of one of the multiple support trusses;
multiple flexures each secured between one of the push rods and the housing; and
multiple actuators each secured to the housing and coupled to one end of one of the multiple push rods.

5. The remotely adjustable optical system of claim 1 wherein the processor and actuator automatically align the optical assembly without exchanging signals with a remote station.

6. A method for adjusting an optical system of a telescope in a satellite, wherein the optical system is misaligned after launch of the satellite, the method comprising:
obtaining at least one image captured by the optical system of the telescope, wherein the captured image is of at least one star;
analyzing the at least one image captured by the optical system of the telescope;
generating adjustment signals to control at least one actuator to move at least one movable element in the optical system and perform positional correction of the optical system,
wherein the positional correction of the optical system is not just a focusing of the optical system, and
wherein the moving of the at least one movable element consists essentially of moving at least one entire or discrete element in the optical system of the telescope, and not moving or deforming a portion of an optical element in the optical system.

7. The method for adjusting an optical system of claim 6 wherein the obtaining of the at least one image includes:
generating multiple signals to control the actuator to move through a select range of positions; and
capturing an image at each of the select range of positions; and
wherein the analyzing of the at least one image includes analyzing each of the captured images to identify an optimal image and providing information for adjusting the movable element based on the identified optimal image.

8. The method for adjusting an optical system of claim 6, wherein the analyzing of the at least one image includes:
analyzing the at least one image captured by the optical system to provide information for adjusting the actuator based on a type of distortion of the captured image of the at least one star.

9. The method for adjusting an optical system of claim 6, further comprising:
generating multiple signals to control the actuator to move through a select range of positions;
capturing an image at each of the select range of positions;
analyzing each of the captured images to identify an optimal image; and
analyzing the at least one image captured by the optical system to generate an adjustment signal for the actuator based on a type of distortion of the captured image of the at least one star and/or the optimal image.

10. The method for adjusting an optical system of claim 6 wherein the at least one image is transmitted to a remote station, and wherein the analyzing of the at least one image is performed at the remote location .

11. The method for adjusting an optical system of claim 6 wherein the obtaining of the at least one image, the analyzing of the at least one image, and the generation of adjustment signals is performed again following at least initial positional correction of the optical system.

12. The method for adjusting an optical system of claim 6 wherein the obtaining of the at least one image, the analyzing of the at least one image, and the generation of adjustment signals are all performed automatically to perform positional correction of the optical system, without exchanging signals with a remote station.

13. A system for adjusting an optical system, wherein the optical system is misaligned after deployment, the system comprising:
means for obtaining at least one image captured by the optical system;
means for analyzing the at least one image captured by the optical system; and,
means for generating adjustment signals to control at least one actuator to move at least one movable element in the optical system and perform positional correction of the optical system based on the analysis of the at least one image, wherein the positional correction of the optical system is not solely a focusing of the optical system, and wherein the moving of the at least one movable element consists essentially of moving at least one entire or discrete element in the optical system, and not moving or deforming a portion of an optical element in the optical system.

14. The system of claim 13 wherein the optical system forms part of an orbital telescope.

15. The system of claim 13 wherein the optical system forms part of a photon receiver for a Light Detection and Ranging (LIDAR) system.

16. A remotely adjustable optical system, comprising:
an optical assembly having at least one discrete movable optical element, and having an imaging element for generating an image;
an adjustment assembly having at least one actuator coupled to the movable optical element of the optical assembly;
a housing for carrying the optical assembly and the adjustment assembly as a unit,
wherein the housing, the optical assembly, and the adjustment assembly are configured to be positioned in space or in an environment hazardous to humans, and
wherein the optical assembly is misaligned when positioned in space or in the hazardous environment;
at least one memory for storing data generated by the imaging element;
at least one processor coupled to the memory,
wherein the processor is configured to execute an optical alignment program to:
analyze the stored data, and
provide adjustment signals to the actuator based on the analysis of the stored image to cause the actuator to actuate the movable optical element and align the optical assembly;
wherein the alignment of the optical assembly is not a focusing of the optical assembly or is not solely a focusing of the optical assembly.

17. A remotely adjustable optical system carried by a housing, the remotely adjustable optical system, comprising:
multiple support trusses each secured at one end to a movable optical element of the optical system;
multiple connection members each secured to a free end of one of the multiple support trusses;
multiple flexures each secured between one of the connection members and the housing; and
multiple actuators each secured to the housing and coupled to one end of one of the multiple connection members.

18. The remotely adjustable optical system of claim 17 wherein the housing and optical system to be positioned in space as a satellite,
wherein the optical system includes a telescope having a stationary primary mirror and the movable optical element is a secondary mirror of the telescope, and
wherein a processor analyzes images taken of a star field to determine a positional correction of the secondary mirror to align the telescope.

19. The remotely adjustable optical system of claim 17 wherein the optical system includes only a single movable optical element,
wherein the single movable optical element is a lens or mirror,
wherein the connection members are push rods,
wherein at least three actuators move the single movable element, via the push rods, about at least three degrees of freedom to perform alignment correction to compensate for misalignment of other optical components and a focal plane of the optical system, and
wherein the moving of the at least one movable element consists essentially of moving at least one entire or discrete element in the optical system, and not moving or deforming a portion of an optical element in the optical system.
